(19) United States
(12) Patent Application Publication
(10) Pub. No.: US 2023/0184315 A1
(43) Pub. Date: Jun. 15, 2023

(54) Gear drive and longitudinal seat adjustment for a motor vehicle

(71) Applicant: IMS GEAR SE & Co. KGaA, Donaueschingen (DE)

(72) Inventors: Steffen ABERLE, Königsfeld (DE); Manuel IRION, Trossingen (DE); Gabriel FUCHS, Reichenau (DE); Manuel HENGSTLER, St. Georgen (DE)

(21) Appl. No.: 18/077,446

(22) Filed: Dec. 8, 2022

(30) Foreign Application Priority Data
Dec. 9, 2021 (EP) 21213494.4

(51) Int. Cl. F16H 55/08; F16H 55/06; F16H 19/08

(52) U.S. Cl. CPC F16H 55/08; F16H 19/08; F16H 55/06; B60N 2/06

(57) ABSTRACT

A gear drive (12) with a first gear (10) which has first tooth flanks (26), and a second gear (30) which has second tooth flanks (32) and which engages with the first gear (10), the first gear (10) having a tip circle (14) with a tip circle radius (16), a root circle (18) with a root circle radius (20) and a modification circle (22) with a modification circle radius arranged between the tip circle (14) and the root circle (18). (24), wherein the first tooth flanks (26) between the root circle (18) and the modification circle (22) each have a recess (28) in such a way that, when the gears (10, 30) mesh, there is no contact between the first tooth flanks (26) and the second tooth flanks (32) between the root circle (18) and the modification circle (22), and a longitudinal seat adjustment for a motor vehicle with a gear drive (12).

The invention relates to a gear drive and a longitudinal seat adjustment for a motor vehicle.

In particular in electromechanical longitudinal seat adjustments in motor vehicles, gear drives are employed, on which high demands in terms of noise and vibration characteristics are placed.

In order to produce gear drives that are extremely low-noise and low-vibration, it is known that the vibration excitation can be reduced by means of a tip relief or an increase in overlap. In the case of the helical gear drives frequently employed in longitudinal seat adjustments, which have a worm and a worm wheel, the tip relief is made on the worm wheel.

However, measures such as the tip relief and the increase in overlap are subject to production-related limitations.

The invention is therefore based on the object of providing a gear drive and a longitudinal seat adjustment for a motor vehicle which have a low level of mechanical and acoustic vibration excitation and are easy to produce in terms of manufacturing technology.

The objects are achieved according to the invention by a gear drive with the features of claim 1 and a longitudinal seat adjustment with the features of claim 11.

Advantageous configurations and developments of the invention are specified in the dependent claims.

A gear drive according to the invention has a first gear with first tooth flanks, and a second gear with second tooth flanks, the second gear engaging with the first gear. The first gear has a tip circle with a tip circle radius, a root circle with a root circle radius and a modification circle with a modification circle radius arranged between the tip circle and the root circle. According to the invention, the first tooth flanks between the root circle and the modification circle each have a recess in such a way that there is no contact between the first tooth flanks and the second tooth flanks between the root circle and the modification circle.

The root circle radius is preferably designed to be smaller than the modification circle radius and the modification circle radius is designed to be smaller than the tip circle radius. As a result, the region of the first tooth flanks, which is preferably referred to as the contact flank and which is intended to be in contact with the second tooth flanks, can be shortened in comparison to conventional gear drives. The contact flank is preferably arranged between the modification circle and the tip circle. By modifying the contact flank in this way, a modified line of engagement of the gear drive can be implemented, which is designed to be significantly flattened in the region of the run-in compared to the ideal line of engagement and the real line of engagement of a conventional gear drive. A flattening of the line of engagement in the run-in region preferably has the effect that the fluctuation in rigidity is reduced in the course of the tooth engagement. A lower fluctuation in the rigidity of the tooth engagement can lead to less rotational non-uniformity of the gear drive and to less vibration excitation. The noise and vibration characteristics of the gear drive can thus be improved by means of the recess, in particular without changing the overlap of the gear drive.

Irrespective of the shortening of the contact flanks, however, the second gear can enter the region between the modification circle and the root circle without the second tooth flanks coming into contact with the first tooth flanks there.

A tooth height can be formed from the difference between tip circle radius and root circle radius, and a modification height can be formed from the difference between modification circle radius and root circle radius. The ratio of the modification height to the tooth height is preferably in the interval from 0.3 to 0.8, preferably in the interval from 0.6 to 0.7. The ratio of modification height to tooth height can depend on the gear ratio of the gear drive. The gear ratio is preferably formed by the ratio of the speed of the second gear to the speed of the first gear. With a gear ratio of 3.25, the ratio of modification height to tooth height is preferably 0.6. With a gear ratio of 3.75, the ratio of modification height to tooth height is preferably 0.67.

In a preferred embodiment of the invention, the first tooth flanks have a first involute geometry, at least in sections, between the modification circle and the tip circle. As a result, a uniform progression of the tooth engagement can be achieved. The first involute geometry can have a very large radius of curvature. The first involute geometry is preferably arranged in the region of the contact flank.

The second tooth flanks can each have a second involute geometry, at least in sections. In particular, in the interaction with the first involute geometry of the first tooth flanks, which is formed at least in sections, a uniform progression of the tooth engagement can thus be achieved. The second involute geometry is preferably arranged in the region of the second tooth flanks which is intended to be in contact with the contact flanks of the first gear.

The invention can be designed in such a way that the first gear and/or the second gear are at least partially made of plastic. Due to the good damping properties of the plastic, the vibration excitation can be further reduced. The first gear and/or the second gear are preferably made, at least partially, from the thermoplastic PEEK. As a result, the corresponding gear can be produced easily and, moreover, can be designed in a cost-effective and low-wear manner.

In addition, the first gear and/or the second gear can be at least partially made of metal. In particular, only the respective tooth flanks, only the teeth of the respective gear or the respective gear can be made entirely of metal or plastic. Preferably, one of the gears is made of plastic and the other gear is made of metal. This allows the properties of metal gears to be combined with the good damping properties of plastic. In addition, the combination of materials can have particularly good sliding properties. As a result, the rolling process in such a gear drive can take place with particularly little wear. The first gear is particularly preferably made of plastic and the second gear is made of metal. It can be particularly easy to place the recess at the plastic gear. In particular, if the conventional gear drive is designed in such a way that the first gear is made of plastic and the second gear is made of metal, the gear drive according to the invention can be provided on this basis with little technical and economic effort.

In a preferred embodiment of the invention, the first tooth flanks are free from an undercut. In particular, if the first gear is made of plastic and is manufactured, for example, by means of a plastic injection molding process, it can be easily manufactured as a result.

The recess particularly preferably has a recess contour which is designed, at least in sections, parallel to a radial direction of the first gear. Such a recess contour can be produced easily. In particular, an extreme large recess can be achieved without the first tooth flanks having an undercut. A corresponding parallel section preferably adjoins the end of the contact flank facing the root circle.

In a preferred embodiment of the invention, the gear drive is designed as a helical gear drive. As a result, a compact design can be realized with a high gear ratio at the same time.

The first gear can be designed as a worm wheel and the second gear can be designed as a worm. The first gear is preferably designed as a worm and the second gear is designed as a worm wheel. The recesses are thus preferably arranged on the tooth flanks of the worm.

A longitudinal seat adjustment according to the invention for a motor vehicle comprises a gear drive according to any one of the preceding claims. The longitudinal seat adjustment can thus meet high demands in terms of noise and vibration characteristics.

An exemplary embodiment of the invention is explained with reference to the following figures. In the figures:

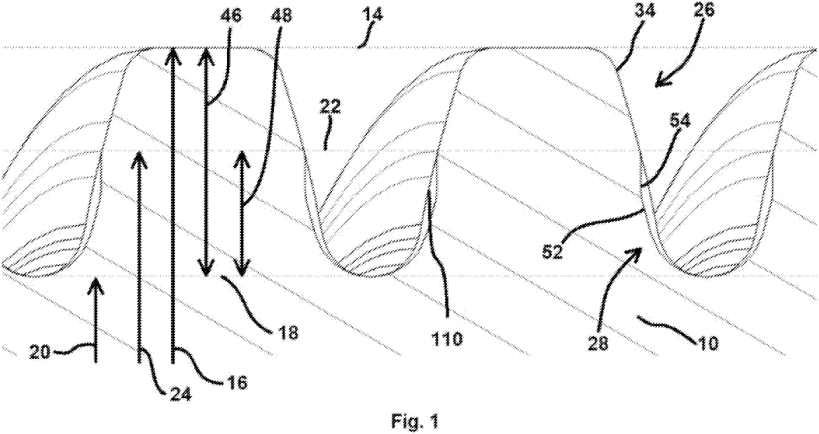

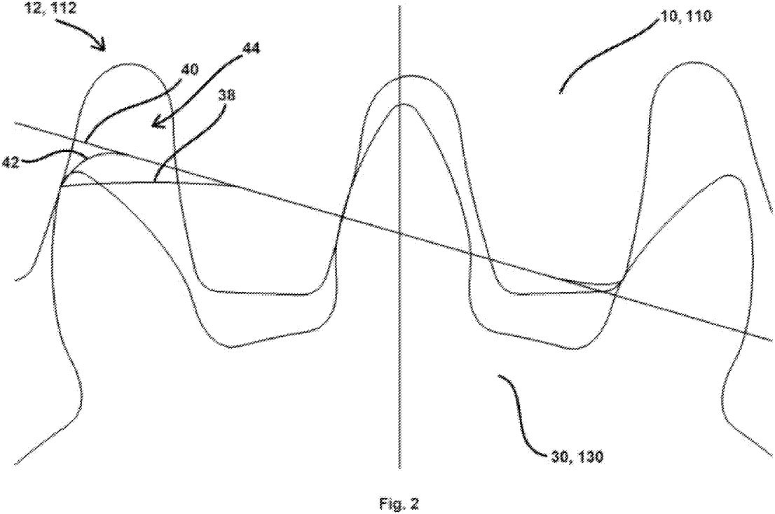

FIG. 1 shows an axial section of a portion of a first gear of a first exemplary embodiment of a gear drive in front of an axial section of a first gear of a first gear drive of the prior art,

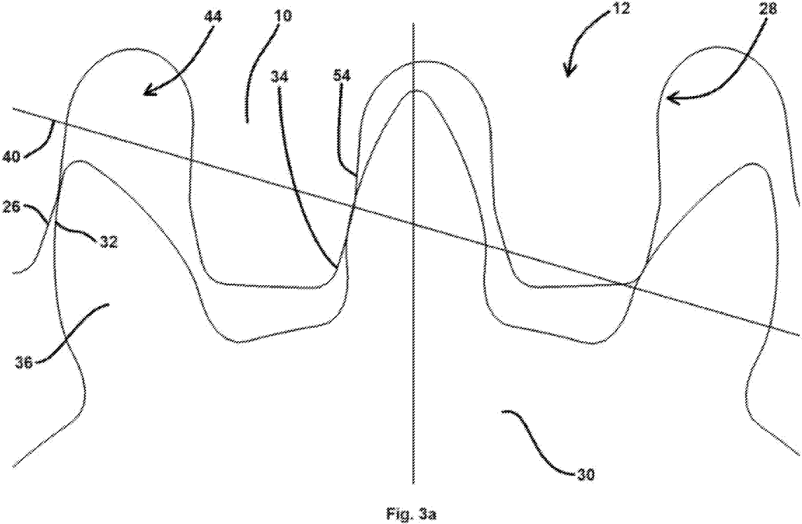

FIG. 2 shows a cross section of the engagement of a gear drive with different lines of engagement,

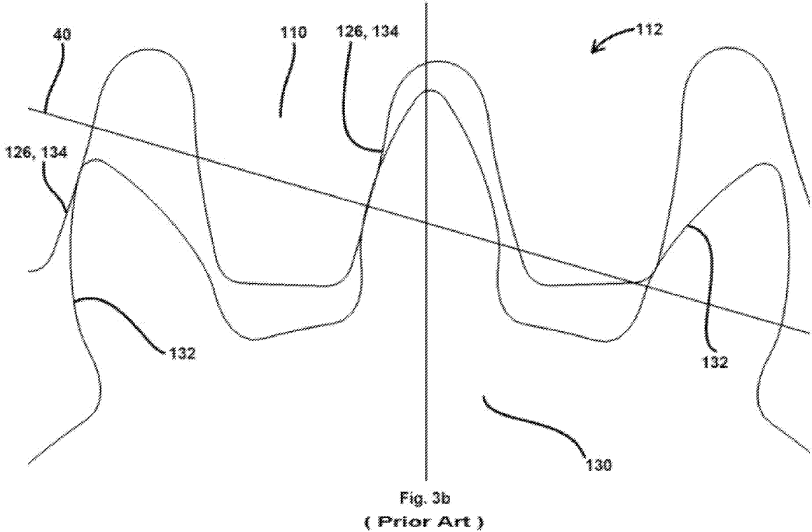

FIG. 3a shows a cross section of the engagement of a second exemplary embodiment of a gear drive in a first position,

FIG. 3b is a cross section of the engagement of a second gear drive of the prior art in the first position;

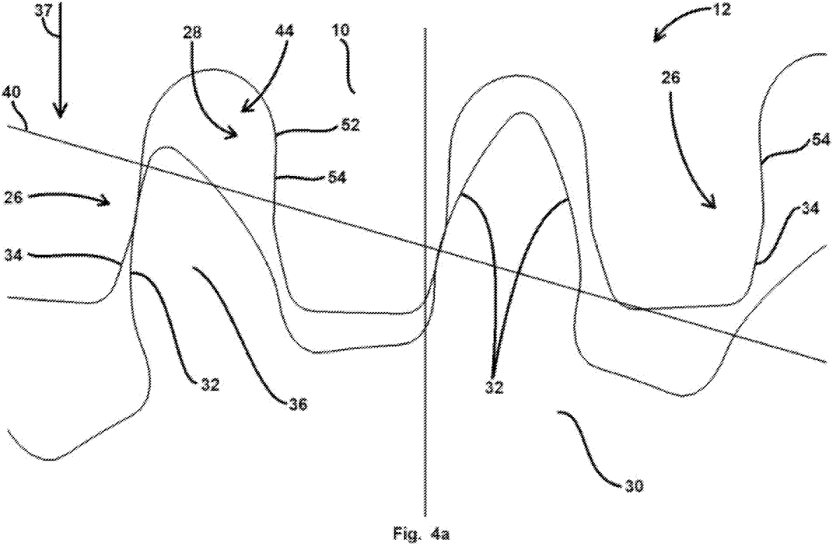

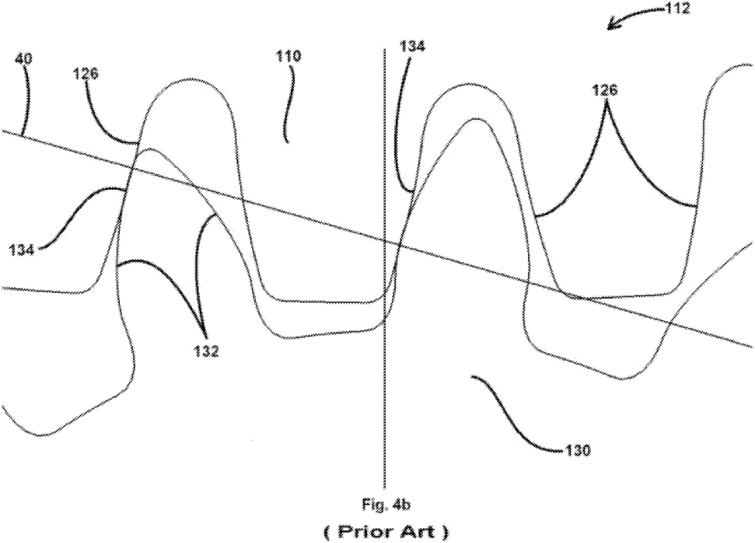

FIG. 4a shows a cross section of the engagement of the exemplary embodiment of a gear drive shown in FIG. 3a in a second position,

FIG. 4b shows a cross section of the engagement of the prior art gear drive shown in FIG. 3b in the second position.

FIGS. 1 to 3a and 4a show different views of different exemplary embodiments. For the sake of clarity, not all reference numerals are used in each figure. The same reference numerals are used for same parts and parts that have the same function.

FIGS. 3b and 4b show different views of a gear drive of the prior art. For the sake of clarity, not all reference numerals are used in each figure. The same reference numerals are used for same parts and parts that have the same function.

FIG. 1 shows a cross section of a portion of a first gear 10 of a first exemplary embodiment of a gear drive 12 in front of a cross section of a first gear 110 of a gear drive 112 of the prior art. The first gear 10 is shown hatched. The prior art first gear 110 has no hatching.

The first gear 10 has a tip circle 14 with a tip circle radius 16, a root circle 18 with a root circle radius 20 and a modification circle 22 with a modification circle radius 24 arranged between the tip circle 14 and the root circle 18. In addition, the first gear 10 has first tooth flanks 26, which each have a recess 28 between the root circle 18 and the modification circle 22. The recess 28 is particularly evident in FIG. 1 in comparison to the first gear 110 of the prior art.

FIGS. 3a and 4a show an exemplary embodiment of a gear drive 12 which, in addition to the first gear 10 with the first tooth flanks 26, has a second gear 30 with second tooth flanks 32, the second gear 30 engaging with the first gear 10. The recesses 28 arranged on the first tooth flanks 26 are designed in such a way that there is no contact between the first tooth flanks 26 and the second tooth flanks 32 between the root circle 18 and the modification circle 22.

In the exemplary embodiments shown in FIG. 1 and FIGS. 3a and 4a, root circle radius 20 is designed to be smaller than modification circle radius 24, and modification circle radius 24 is designed to be smaller than tip circle radius 16. As a result, the region of the first tooth flanks 26 designated as the contact flank 34, which is intended to be in contact with the second tooth flanks 32, can be shortened in comparison to the contact flanks 134 of the conventional gear drives 112. The contact flank 34 is preferably arranged between the modification circle 22 and the tip circle 14.

Irrespective of the shortening of the contact flanks 34, however, second gear 30 can enter the region between modification circle 22 and root circle 18 without second tooth flanks 32 coming into contact with first tooth flanks 26 there.

The shortening of the contact flanks 34 is apparent in particular from FIGS. 4a and 4b. While FIG. 4a shows a gear drive 12 according to the invention, FIG. 4b shows a corresponding conventional gear drive 112 without recesses 28. In FIGS. 4a and 4b, gear drives 12, 112 are shown in the same position, i.e. at the same point of engagement. The position shown in FIGS. 4a and 4b is the position in which the difference in engagement between gear drive 12 according to the invention and conventional gear drive 112 becomes maximum. The contact between first tooth flank 26 and second tooth flank 32 of a run-in tooth 36 of second gear 30 takes place significantly further outwards in relation to a radial direction 37 of first gear 10 (FIG. 4a) than is the case in corresponding gear drive 112 of the prior art (FIG. 4b).

Such a modification of the contact flank 34 allows a modified line of engagement 38 of gear drive 12 to be implemented, which is designed to be significantly flattened in a run-in region 44 compared to ideal line of engagement 40 and real line of engagement 42 of conventional gear drive 112 (see FIG. 2). In the case of gear pairings, run-in region 44 usually represents the region in which the engagement of teeth begins. In FIG. 2 to 4b, first gear 10 is designed as a driving gear, so that the run-in region 44 is arranged on the left in these figures. The flattening of modified line of engagement 38 in run-in region 44 preferably leads to the fluctuation in rigidity over the course of the engagement is reduced. The noise and vibration characteristics of gear drive 12 can be improved by reducing a fluctuation in rigidity over the course of the tooth engagement that is achieved in this way.

As shown in FIG. 2, real line of engagement 42 of conventional gear drive 112 and modified line of engagement 38 of gear drive 12 approach ideal line of engagement 40 in the course of tooth engagement. The contact between first tooth flanks 26 and second tooth flanks 32 therefore differs, particularly in the run-in region, from the contact of first tooth flanks 126 of first gear 110 with second tooth flanks 132 of a second gear 130 of conventional gear drive 112. The difference summarized in FIG. 2 is illustrated in FIGS. 3a to 4b, where the positions of the tooth engagement of gear drive 12 shown in FIGS. 3a and 4a are compared with the respective corresponding position of the tooth engagement of conventional gear drive 112 in FIGS. 3b and 4b. For illustration purposes, ideal line of engagement 40 is drawn in FIGS. 3a to 4b as a reference.

As shown in FIG. 1, a tooth height 46 can be formed from the difference between tip circle radius 16 and root circle radius 20. A modification height 48 can be formed from the difference between modification circle radius 24 and root circle radius 20. The ratio of modification height 48 to tooth height 46 can depend on the gear ratio of gear drive 12. With a gear ratio of 3.25, the ratio of modification height 48 to tooth height 46 is preferably 0.6. With a gear ratio of 3.75, the ratio of modification height 48 to tooth height 46 is preferably 0.67.

In the exemplary embodiments shown in FIG. 1 and FIGS. 3a and 4a, first tooth flanks 26 have a first involute geometry in sections between modification circle 22 and tip circle 14. The first involute geometry can have a very large radius of curvature and is arranged in the region of contact flank 34. In the exemplary embodiment of gear drive 12 shown in FIGS. 3a and 4a, second tooth flanks 32 each have a second involute geometry, at least in sections. The second involute geometry is preferably arranged in the region of second tooth flanks 32 and is intended to be in contact with contact flanks 34 of first gear 10.

Gear drives 12, 112 shown in FIG. 2 to 4b are designed as helical gear drives. In this case, first gear 10, 110 is designed as a worm and second gear 30, 130 is designed as a worm wheel. Thus, recesses 28 of first tooth flanks 26 are arranged on the tooth flanks of the worm. First gear 10 shown in FIG. 1 is also provided for a helical gear drive and is designed as a worm.

In gear drives 12, 112 shown in FIG. 2 to 4b, first gear 10, 110, i.e. the worm, is made of PEEK plastic in each case. In each case second gear 30, 130, i.e. the worm wheel, is made of metal.

In the exemplary embodiments shown in FIG. 1 and in FIGS. 3a and 4a, first tooth flanks 26 are free from an undercut. Each of recesses 28 has a recess contour 52 which is designed parallel to a radial direction 54 of first gear 10, at least in sections. A corresponding parallel section 54 adjoins the end of contact flank 34 facing root circle 18.

### LIST OF REFERENCE NUMERALS

10 first gear
12 gear drive
14 tip circle
16 tip circle radius
18 root circle
20 root circle radius
22 modification circle
24 modification circle radius
26 first tooth flank
28 recess
30 second gear
32 second tooth flank
34 contact flank
36 run-in tooth
37 radial direction
38 modified line of engagement
40 ideal line of engagement
42 real line of engagement of the conventional gear drive
44 run-in region
46 tooth height
48 modification height
52 recess contour
54 parallel section
110 first gear (prior art)
112 gear drive (prior art)
126 first tooth flanks (prior art)
130 second gear (prior art)
132 second tooth flanks (prior art)
134 contact flank (prior art)

1. A gear drive (12) with a first gear (10) which has first tooth flanks (26), and a second gear (30) which has second tooth flanks (32) and which engages with the first gear (10), the first gear (10) having a tip circle (14) with a tip circle radius (16), a root circle (18) with a root circle radius (20) and a modification circle (22) with a modification circle radius arranged between the tip circle (14) and the root circle (18). (24),
characterized in that the first tooth flanks (26) between the root circle (18) and the modification circle (22) each have a recess (28) in such a way that, when the gears (10, 30) mesh, there is no contact between the first tooth flanks (26) and the second tooth flanks (32) between the root circle (18) and the modification circle (22).

2. The gear drive according to claim 1, characterized in that a tooth height (46) is formed from the difference between tip circle radius (16) and root circle radius (20) and a modification height (48) is formed from the difference between modification circle radius (24) and root circle radius (20), wherein the ratio of modification height (48) to tooth height (46) is in the interval from 0.3 to 0.8, preferably in the interval from 0.6 to 0.7.

3. The gear drive according to claim 1,
characterized in that the first tooth flanks (26) have a first involute geometry, at least in sections, between the modification circle (22) and the addendum circle (14).

4. The gear drive according to claim 1, characterized in that the second tooth flanks (32) each have a second involute geometry, at least in sections.

5. The gear drive according claim 1, characterized in that the first gear (10) and/or the second gear (30) are at least partially made of plastic.

6. The gear drive according to claim 1, characterized in that the first gear (10) and/or the second gear (30) are at least partially made of metal.

7. The gear drive according to claim 1, characterized in that the first tooth flanks (26) are free from an undercut.

8. The gear drive according to claim 1, characterized in that the recess (28) has a recess contour (52) which is designed, at least in sections, parallel to a radial direction (37) of the first gear (10).

9. The gear drive according to claim 1, characterized in that the gear drive (12) is designed as a helical gear drive.

10. The gear drive according to claim 9, characterized in that the first gear (10) is designed as a worm and the second gear (30) as a worm wheel or the first gear (10) as a worm wheel and the second gear (30) as a worm.

11. A longitudinal seat adjustment for a motor vehicle with a gear drive (12) according to claim 1.
